(19) United States
(12) Patent Application Publication
(10) Pub. No.: US 2007/0092690 A1
(43) Pub. Date: Apr. 26, 2007

(54) Interior finishing component for a motor vehicle

(75) Inventors: Helmut Gocht, Monsheim (DE); Roland Buhner, Fellbach-Schmiden (DE); Andrew Wilkinson, Weil der Stadt (DE)

Correspondence Address: LERNER GREENBERG STEMER LLP, P O BOX 2480, HOLLYWOOD, FL, 33022-2480, US

(73) Assignee: Dr. Ing. h.c.F. Porsche AG

(21) Appl. No.: 11/584,267

(22) Filed: Oct. 20, 2006

(30) Foreign Application Priority Data
Oct. 20, 2005 (DE) 10 2005 050 242.3

(51) Int. Cl. B32B 1/00

(52) U.S. Cl. 428/100; 428/174

(57) ABSTRACT

An interior finishing component, in particular an interior paneling part for a motor vehicle, has a basic body with a foam material and a reinforcing insert within the basic body. For simple fastening of the interior finishing component to the motor vehicle, it is provided that the foam material of the basic body comprises a flexible soft foam part, that at least two reinforcing inserts which are situated at a spacing distance from each other are arranged within the basic body, and that the interior finishing component has at least one engage-behind element for its fastening to the motor vehicle.

### CROSS-REFERENCE TO RELATED APPLICATION

This application claims the priority, under 35 U.S.C. § 119, of German patent application DE 10 2005 050 242.3, filed Oct. 20, 2005; the prior application is herewith incorporated by reference in its entirety.

### BACKGROUND OF THE INVENTION

1. Field of the Invention

The invention pertains to an interior finishing component, in particular an interior paneling part, for a motor vehicle. The component has a basic body with a foam material and at least one reinforcing insert disposed within the basic body.

Such an interior finishing component is known from European published patent application EP 44 36 64 A2. It comprises a foamed basic body (core layer) in which a foamed reinforcing insert which has a higher density than the basic body is arranged. The reinforcing insert, which is provided locally, serves as a fastening point for screws or fittings. In addition, a fiber-reinforced cover layer is also applied to the basic body and confers a certain degree of rigidity on the interior finishing component.

German published patent application DE 102 53 825 A1 describes an interior finishing component for a motor vehicle, which can be designed as a paneling part or add-on part. It comprises a foamed basic body to which an outer reinforcing layer is applied.

### SUMMARY OF THE INVENTION

It is accordingly an object of the invention to provide an interior finishing component for a motor vehicle which overcomes the above-mentioned disadvantages of the heretofore-known devices and methods of this general type and which provides for such a component, in particular an interior paneling part, which has a sufficient degree of stability and rigidity and can be fastened to the motor vehicle in a simple manner.

With the foregoing and other objects in view there is provided, in accordance with the invention, an interior finishing component for a motor vehicle, in particular an interior panel. The component comprises:
a basic body formed with a flexible soft foam part of foam material;
at least two reinforcing inserts disposed within said basic body at a spacing distance from one another; and
at least one engage-behind element for fastening the finishing component to the motor vehicle.

The advantages primarily achieved with the invention are considered that of allowing the basic body comprising the flexible soft foam part to bend or to buckle to a certain extent, as a result of which the at least one engage-behind element can be brought into engagement with the motor vehicle in order to fasten the interior finishing component to the motor vehicle. Owing to the fact that the reinforcing inserts are situated at a distance from each other, the abovementioned bending or buckling of the basic body is made possible, since the reinforcing inserts are not present continuously in the basic body. Nevertheless, the reinforcing inserts confer a certain degree of rigidity and stability on the basic body, with the result that the interior finishing component can also be used in an advantageous manner for relatively large parts, in particular paneling parts. In a particularly preferred use, the interior finishing component according to the invention is used in a motor vehicle as a rear parcel shelf or luggage dump. In a particularly preferred embodiment, it furthermore serves as an insulating means, if the rear parcel shelf is arranged above an engine compartment for the drive unit of the motor vehicle, as is provided in particular in the case of motor vehicles with a mid-engine or rear-engine arrangement, since, in the case of vehicles of this type, the engine compartment is directly adjacent to the vehicle interior and a partition of the engine compartment in these vehicles can form a trunk floor or a rear parcel shelf. The use of a soft foam for the basic body also enables the interior finishing component according to the invention to have a sufficient degree of sound insulation.

To be able to be produced in a simple manner, it is provided that the entire basic body is designed as a soft foam part. In principle, however, it would be conceivable to design the basic body as a soft foam part only in the region in which the reinforcing inserts are at a distance from each other, thus permitting the abovementioned bending or buckling of the basic body.

For improved insulation of the interior finishing component, a visco-elastic soft foam may be used, since the visco-elastic properties permit an efficient dissipation of the vibrations registered.

For a good degree of stability and rigidity of the basic body with a particularly low weight, according to claim 4 the reinforcing inserts are likewise produced from foam material, with a foam material being selected which has a harder setting than the soft foam of the basic body. This can preferably be a polystyrene foam which is also known under the name Styropor® or Styrofoam. A polyurethane foam, in particular, can be used as the soft foam for the basic body.

In accordance with an added feature of the invention, the reinforcing inserts have mutually facing side surfaces formed with bevels. The possibility of bending or buckling the interior finishing component is simplified, since a larger intermediate space is produced between the beveled side surfaces, in which the soft foam of the basic body is arranged.

In accordance with an additional feature of the invention, the engage-behind element, i.e., at least one such element, is fastened to the basic body.

In order to be able to further stabilize the basic body, a flexurally stiff film is applied to the basic body, at least in some regions thereof.

In accordance with a particularly advantageous embodiment of the invention, the flexurally stiff film protrudes somewhat over the basic body with at least one extension. The extension can form the engage-behind element.

For secure fastening, the engage-behind element is of hook-shaped design.

In accordance with another feature of the invention, the interior finishing component is provided with a decorative layer, in particular if it is used as an interior paneling part for a motor vehicle. This decorative layer faces the vehicle interior and is applied to the flexurally stiff film. By way of example, it is adhesively bonded or laminated onto it. Of course, a “flocking” of the flexurally stiff film would also be possible.

In order to be able to produce the interior finishing component in a simple and cost-effective manner, the flexurally stiff film is adhesively bonded to the basic body. For this purpose, it is provided, in particular, to first of all provide the flexurally stiff film with the decorative layer and subsequently to adhesively bond it on to the basic body.

Other features which are considered as characteristic for the invention are set forth in the appended claims.

Although the invention is illustrated and described herein as embodied in interior finishing component for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a partial, perspective rear view of a motor vehicle with an interior finishing component according to the invention;

FIG. 2 is a sectional view through the interior finishing component taken along the line II-II in FIG. 1;

FIG. 3 is a sectional view through the interior finishing component taken along the line III-III in FIG. 1;

FIG. 4 is a sectional view through the interior finishing component taken along the line IV-IV in FIG. 1; and

FIG. 5 is a sectional view through the interior finishing component taken along the line V-V in FIG. 1.

### DESCRIPTION OF THE PREFERRED EMBODIMENTS

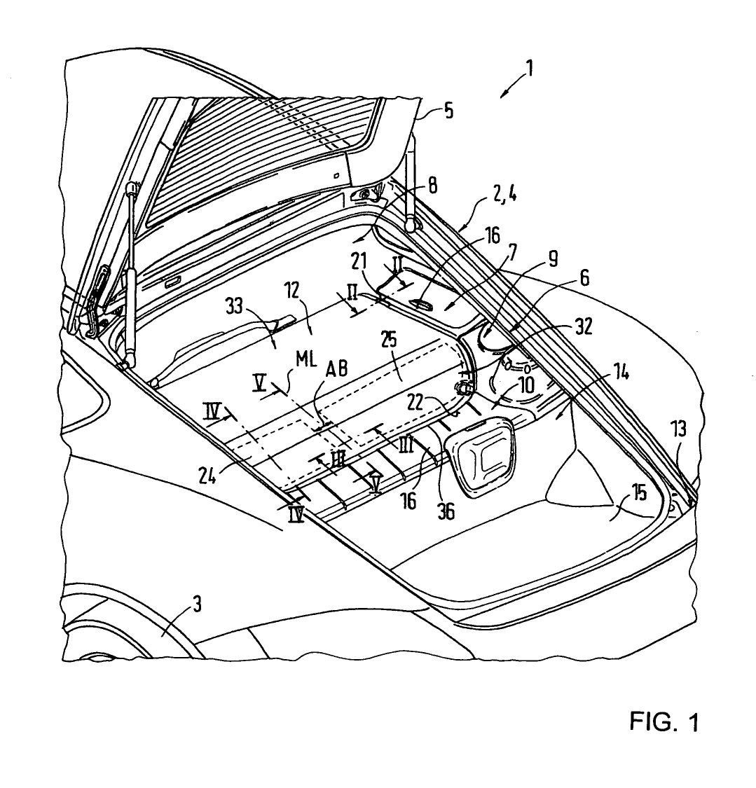

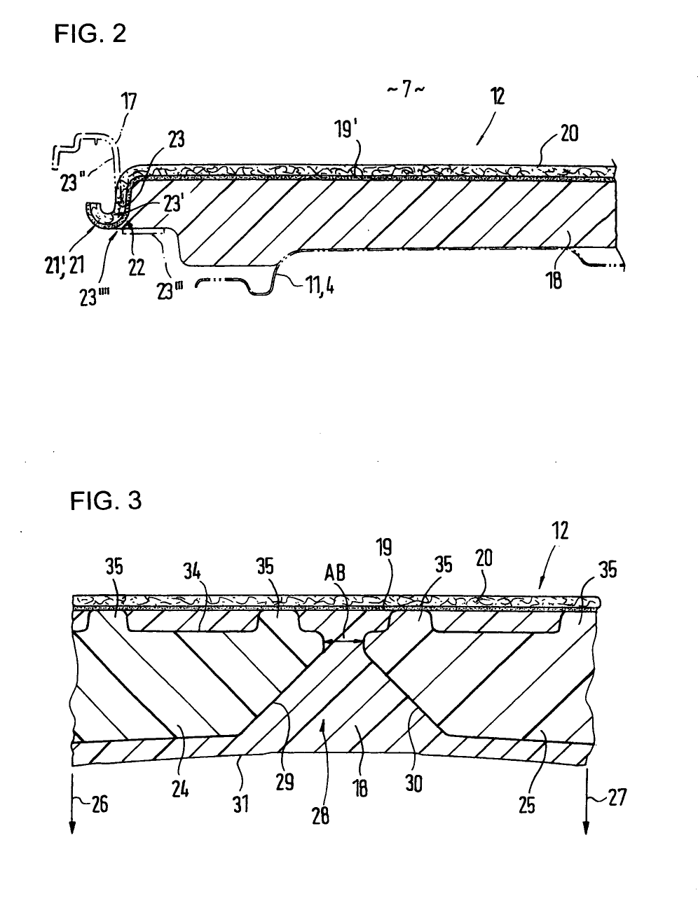

Referring now to the figures of the drawing in detail and first, particularly, to FIG. 1 thereof there is shown a part of a motor vehicle 1, in particular a passenger vehicle, with a vehicle body 2 which is supported by a chassis with wheels 3. The vehicle body 2 comprises a bodywork 4 with add-on parts, such as, for example, a tailgate 5, which is pivotally fastened to the bodywork 4 and closes or—as illustrated in FIG. 1—opens up a bodywork opening 6. The bodywork 4 surrounds a continuous vehicle interior 7 which here comprises a passenger compartment 8 with seats (not illustrated) and a luggage compartment 9, which luggage compartment 9 is accessible via the bodywork opening 6. The luggage compartment 9 is bounded, inter alia, by a lined luggage compartment floor 10 which is part of the bodywork 4 and which separates the luggage compartment 9 from an engine compartment (which cannot be seen here) in which the drive unit, comprising an engine and a transmission, of the motor vehicle 1 is accommodated. In this motor vehicle 1, the drive unit is a center-engine assembly (the engine is disposed between the axles in a plan view); alternatively, a rear-engine assembly would be possible. So that the engine compartment is accessible from above—for example for maintenance work—the luggage compartment floor 10 has a removable engine covering 11 (see FIGS. 2, 4 and 5) which closes an opening in the luggage compartment floor 10 and can be designed, for example, as a sheet-metal part. Above the engine covering 11, there is arranged on the luggage compartment floor 10 an interior finishing component 12 which is arranged with a front edge section of its circumferential edge 22 directly adjacent to the passenger compartment 8 and can therefore form a rear parcel shelf. The interior finishing component 12 can be used as a wall into a recess or opening of the bodywork 4 or can cover a bodywork wall, here the luggage compartment floor 10 or the engine covering 11. In the present exemplary embodiment, the interior finishing component 12 forms an interior paneling part of the vehicle interior 7, in particular of the luggage compartment 9. As seen in the direction of the vehicle rear 13, a further section 15 of the luggage compartment floor 10 adjoins via a dropping step 14, which section 15 can extend into the rear region 13. Adjacent to the interior finishing component 12, in the exemplary embodiment shown, further interior paneling parts 16, 17 are assigned to the interior equipment in the vehicle interior 7. The interior finishing component 12 is fastened releasably to the bodywork 4 and/or to the interior equipment, i.e. to at least one interior paneling part 16, 17.

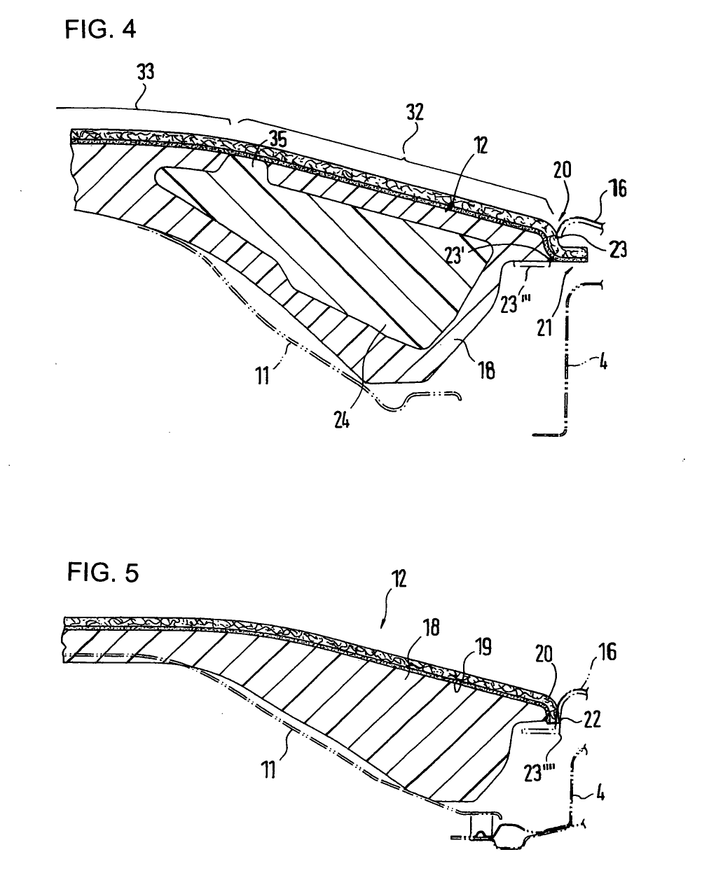

The interior finishing component 12 from FIG. 1 is explained in more detail below with reference to FIGS. 2 to 5. According to FIG. 2, the interior finishing component 12 has a basic body 18 which is produced from foam material comprising a soft foam, for which purpose a polyurethane foam, PUR foam for short, is preferably provided which has, for example, a density of 60+10/−5 kg/m³. The basic body 18 can be matched on its lower side 31, which is situated facing the engine compartment covering 11, to the contour of this engine compartment covering 11 at least in some regions and approximately. On its upper side 19′ which is situated facing the vehicle interior 7, the basic body 18 is preferably provided over its entire surface with a flexurally stiff film 19, which can be adhesively bonded onto the basic body 18. This flexurally stiff film 19 is preferably designed as a heavy EPDM film and, on its side facing the vehicle interior 7, can be provided with a decorative layer 20 which is designed, for example, as carpet, flocking, covering or the like. As emerges from FIG. 2, the flexurally stiff film 19 protrudes with at least one strip-shaped extension 21 over the circumferential edge 22 of the basic body 18. A plurality of extensions 21 can be provided distributed over the circumferential edge and form fastening elements of a device for fastening the interior finishing component 12 to the motor vehicle 1 or to the adjacent interior equipment parts 16 or 17. The extension 21 engages under or behind an edge 23 of the particular interior equipment part 16 or 17. The extension 21 emerges from the basic body 18 and, in particular, is fastened thereto. The extensions 21 of the fastening device form engage-behind elements 21′ which can engage behind the particular interior paneling part 16 or 17 and can be of hook-shaped configuration. Alternatively, the extensions 21 could act on the bodywork 4, for example a bodywork wall. In FIG. 2, the engage-behind element with the extension 21 is realized in the shape of a hook—as seen in cross section. In the case of the extension 21 according to FIG. 4, the extension 21 emerges rectilinearly and engages under the circumferential edge 23 of the interior paneling part 16. The edge 23 may be a boundary edge of the particular interior paneling part 16 or 17. Alternatively, the edge 23 could be a circumferential edge of an aperture 23′ in the interior paneling part 16 or 17, into which the extension 21 is fitted, reaching through this aperture. The aperture 23′ is preferably inserted into a first wall section 23″ of the interior paneling part 16 or 17. The first wall section 23″ is adjoined by a second wall section 23′″ which extends under the basic body 18. During the fastening of the interior finishing component, the extension 21 can slide on this second wall section 23′″ and can be guided through the aperture 23′. The aperture 23′ can extend into a corner region 23″″ between first and second wall sections 23″ and 23′″. This can apply in analogous manner if the extension 21 is to be brought into engagement with the bodywork 4 or a bodywork wall.

At least two reinforcing inserts 24 and 25 are inserted into the basic body 18 and can be arranged within the basic body, for example by having the soft foam of the basic body 18 foamed around them. The two reinforcing inserts 24 and 25 are situated—as revealed in FIGS. 1 and 3—at a distance AB from each other, as a result of which the basic body 18, which is produced from the flexible soft foam, can be bent or buckled about a bending line, here a central longitudinal axis ML, which coincides with the intersecting line V-V, in accordance with the arrow direction 26 and 27, so that the extensions 21 forming the engage-behind elements 21′ can be inserted or fitted under the particular edge 23 of the adjacent paneling part 16 or 17. The distance AB between the two reinforcing inserts 24 and 25 results between the reinforcing paneling parts 24 and 25 in an intermediate space 28 which is filled with the soft foam of the basic body 18. As is also apparent from FIG. 3, the mutually facing side surfaces 29 and 30 of the two reinforcing inserts 24 and 25 are of beveled design in such a manner that the intermediate space 28 widens in the direction of the lower side 31 of the basic body, as a result of which a relatively large bending or buckling angle about the central longitudinal axis ML is provided for the basic body 18 or the interior finishing component 12. The reinforcing inserts 24 and 25 are produced from a material which is of harder design than the soft foam of the basic body 18. In particular, the reinforcing inserts 24 and 25 are likewise produced from foam material, with use preferably being made of a polystyrene foam, EPS foam for short, which, in particular, has a density of 30±10 kg/m³.

As emerges from FIG. 1, the reinforcing inserts 24 and 25 extend essentially over the entire width but only over a partial length of the interior finishing component 12. As seen in cross section, the reinforcing inserts 24 and 25 are of approximately wedge-shaped design, with the wedge shape (FIG. 4) being oriented in such a manner that the cross section of the reinforcing inserts 24 and 25 increases in the direction of the paneling part 16. It furthermore emerges from FIG. 4 that, in a sloping down end region 32 which is situated adjacent to the paneling part 16, the interior finishing component 12 with the basic body 18 has a substantially greater material thickness than in a section 33 of the interior finishing component 12 which is arranged upstream and runs approximately horizontally. The reinforcing inserts 24 and 25 are preferably situated in the end region 32. In addition, they have—as illustrated in FIGS. 3 and 4—on their upper side 34 facing the film 19 one or more elevations 35 on which the film 19 rests. These elevations can be of knob-like or spot-shaped, strip-shaped, circular or similar design.

As FIG. 5 shows, in the remaining regions of the circumferential edge 22 of the interior finishing component, the decorative layer 20 bears against the adjacent paneling part 16, to be precise in the regions which are designed without the extensions 21. The strip-shaped extensions 21 can—as illustrated in FIGS. 2 and 4—reach through the corresponding paneling parts 16 and 17 in the apertures 23′, thus resulting in the engagement behind for the fastening of the interior finishing component 12 to the corresponding paneling parts 16 and 17. It is furthermore apparent that the decorative layer 20 can also be fixed on the extensions 21, as a result of which a certain damping of sound is obtained, since the film 19 and the paneling parts 17 do not rest directly on each other. It can furthermore also be seen that the soft foam of the basic body 18 is recessed in the region of the extensions 21.

We claim

1. An interior finishing component for a motor vehicle, comprising:
a basic body formed with a flexible soft foam part of foam material;
at least two reinforcing inserts disposed within said basic body at a spacing distance from one another; and
at least one engage-behind element for fastening the finishing component to the motor vehicle.

2. The interior finishing component according to claim 1, wherein the entire said basic body is a soft foam part.

3. The interior finishing component according to claim 1, wherein said soft foam part is produced from a visco-elastic soft foam.

4. The interior finishing component according to claim 1, wherein said foam material is polyurethane foam.

5. The interior finishing component according to claim 1, wherein said reinforcing inserts are formed of a harder foam material than the foam material of said basic body.

6. The interior finishing component according to claim 5, wherein said reinforcing inserts are produced from a polystyrene foam.

7. The interior finishing component according to claim 1, wherein said reinforcing inserts have mutually facing side surfaces formed with bevels.

8. The interior finishing component according to claim 1, wherein said engage-behind element is fastened to said basic body.

9. The interior finishing component according to claim 1, which further comprises a flexurally stiff film applied to said basic body, at least in some regions thereof.

10. The interior finishing component according to claim 9, wherein said flexurally stiff film protrudes over said basic body with at least one extension, and said extension forms said engage-behind element.

11. The interior finishing component according to claim 1, wherein said engage-behind element is hook-shaped.

12. The interior finishing component according to claim 1, wherein said engage-behind element has a rectilinear configuration.

13. The interior finishing component according to claim 1, which further comprises a decorative layer on a paneling side of the component facing a vehicle interior.

14. The interior finishing component according to claim 13, which further comprises a flexurally stiff film applied to said basic body, at least in some regions thereof, and wherein said decorative layer is fixed on said flexurally stiff film.

15. The interior finishing component according to claim 1, which further comprises a flexurally stiff film adhesively bonded onto said basic body.

16. The interior finishing component according to claim 1 configured as an interior paneling part of the motor vehicle.
